(19) United States
(12) Patent Application Publication
(10) Pub. No.: US 2022/0261955 A1
(43) Pub. Date: Aug. 18, 2022

(54) IMAGE PROCESSING APPARATUS, IMAGE CAPTURING APPARATUS, IMAGE PROCESSING METHOD, AND MEDIUM

(71) Applicant: CANON KABUSHIKI KAISHA, Tokyo (JP)

(72) Inventor: Atsushi Takahama, Kanagawa (JP)

(21) Appl. No.: 17/732,979

(22) Filed: Apr. 29, 2022

Related U.S. Application Data
(63) Continuation of application No. PCT/JP2020/043619, filed on Nov. 24, 2020.

(30) Foreign Application Priority Data
Nov. 29, 2019 (JP) 2019-217503

(51) Int. Cl. G06T 3/40; G06T 5/00

(52) U.S. Cl. CPC G06T 3/4015; G06T 3/4046; G06T 2207/20084; G06T 2207/20081; G06T 5/009

(57) ABSTRACT

An image processing apparatus is provided. First image data is generated from RAW image data by performing nonlinear conversion. Second image data is generated by performing a demosaicing process on RAW image data using a neural network trained using the first image data. A development process is performed using the second image data.

### CROSS-REFERENCE TO RELATED APPLICATIONS

This application is a Continuation of International Patent Application No. PCT/JP2020/043619, filed Nov. 24, 2020, which claims the benefit of Japanese Patent Application No. 2019-217503, filed Nov. 29, 2019, both of which are hereby incorporated by reference herein in their entirety.

### BACKGROUND OF THE INVENTION

### Field of the Invention

The present invention relates to an image processing apparatus, an image processing method, an image capturing apparatus, and a medium, and in particular to demosaicing processing that is performed on an image.

### Background Art

Light of a specific wavelength is incident to the pixels of an image sensor of a digital image capturing apparatus such as a digital camera through color filters in an RGB array, for example. Color filters in a Bayer array are used in many cases, for example. A captured image with a Bayer array is what is known as a mosaic image, in which each pixel has only a pixel value corresponding one color out of RGB colors. In development processing that is performed by a camera or the like, a color image is generated by performing, on such a mosaic image, demosaicing processing for obtaining pixel values of the remaining two colors through interpolation and other signal processing.

Linear interpolation and the like are known as conventional demosaicing processing techniques, but, in recent years, interpolation techniques in which a deep training technique is applied have been proposed. For example, Gharbi (M. Gharbi et al. “Deep Joint Demosaicking and Denoising”, Siggraph Asia 2016.) discloses a demosaicing processing technique that uses a CNN (convolutional neural network).

### SUMMARY OF THE INVENTION

According to an embodiment of the present invention, an image processing apparatus comprises one or more processors and one or more memories storing one or more programs which cause the one or more processors to: generate first image data from RAW image data by performing nonlinear conversion; generate second image data by performing a demosaicing process on RAW image data using a neural network trained using the first image data; and perform a development process using the second image data.

According to another embodiment of the present invention, an image capturing apparatus comprises: an image capturing sensor; and one or more processors and one or more memories storing one or more programs which cause the one or more processors to: generate first image data from RAW image data obtained by the image capturing sensor, by performing nonlinear conversion; generate second image data by performing a demosaicing process on RAW image data using a neural network trained using the first image data; perform a development process using the second image data; generate a set consisting of supervisory image data that has color information in a nonlinear color space and training image data that is mosaic image data of the supervisory image data, based on the RAW image data; and train the neural network that is used for a demosaicing process, based on the set consisting of the supervisory image data and the training image data.

According to still another embodiment of the present invention, an image processing method comprises: generating first image data from RAW image data by performing nonlinear conversion; generating second image data by performing a demosaicing process on RAW image data using a neural network trained using the first image data; and performing a development process using the second image data.

According to yet another embodiment of the present invention, a non-transitory computer-readable medium stores one or more programs which, when executed by a computer comprising one or more processors and one or more memories, cause the computer to: generate first image data from RAW image data by performing nonlinear conversion; generate second image data by performing a demosaicing process on RAW image data using a neural network trained using the first image data; and perform a development process using the second image data.

Further features of the present invention will become apparent from the following description of exemplary embodiments with reference to the attached drawings.

### BRIEF DESCRIPTION OF THE DRAWINGS

FIG. 1 is a block diagram showing an exemplary hardware configuration of an image processing apparatus according to an embodiment of the present invention.

FIGS. 2A-2C are block diagrams showing an exemplary functional configuration of an image processing apparatus according to an embodiment of the present invention.

FIG. 3 is a flowchart of an image processing method according to an embodiment of the present invention.

FIG. 4 is a block diagram showing an exemplary functional configuration of a training apparatus according to an embodiment of the present invention.

FIG. 5 is a flowchart of a training method according to an embodiment of the present invention.

FIGS. 6A-6C are schematic diagrams showing an example of a neural network.

FIGS. 7A-7C are schematic diagrams showing an example of a method for generating a correct answer image from a RAW image data.

FIGS. 8A-8B are schematic diagrams showing an example of a method for constructing training data sets.

FIG. 9 is a schematic diagram showing a flow of training processing.

FIG. 10 is a schematic diagram showing a flow of difficult data extraction processing.

FIGS. 11A-11B are diagrams showing a result of demosaicing processing.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

It has been found that, when demosaicing processing described in Gharbi is used in development processing of a RAW image obtained by an image capturing apparatus, a false pattern is still formed.

The inventor of the present application has found that, when the demosaicing method described in Gharbi is applied to development processing of a RAW image obtained by an image capturing apparatus, a false pattern is likely to be formed particularly in the vicinity of an edge, inter alia in the vicinity of a high-contrast edge. The inventor of the present application estimated that the reason for this is that a neural network was trained using an image in a linear color space that has a relatively low contrast compared with a developed image. Accordingly, it can be said that training that uses an image in a linear color space is training that uses data on which interpolation processing is relatively easily performed, and that this training may result in lower interpolation accuracy of demosaicing processing in an edge portion than training that uses a developed image. For this reason, there is a possibility that sufficient training has not been performed using data that is difficult to perform interpolation processing. Particularly, even when such difficult data is extracted from training data to perform further training, it can be said that the difficult data extracted from an image in a linear color space in this manner is training data on which interpolation processing can be relatively easily performed.

According to the following embodiments made in light of such findings, it is possible to accurately perform demosaicing processing in development processing of a RAW image obtained by an image capturing apparatus.

According to an embodiment of the present invention, for example, it is possible to obtain a color image in which moire is suppressed and the bandwidth is widened.

### First Embodiment

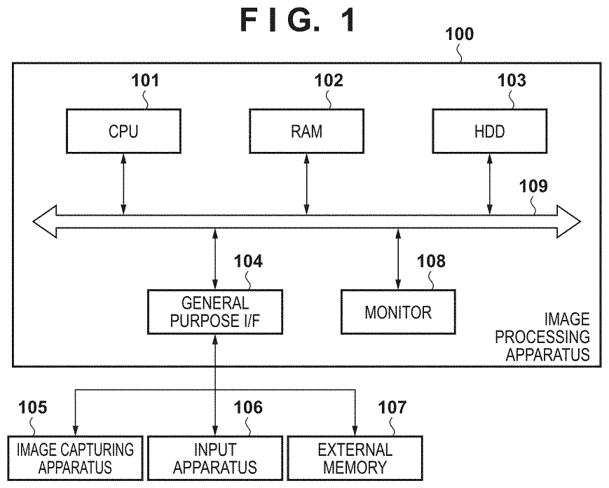

An image processing apparatus according to a first embodiment can be realized by a computer that includes a processor and a memory. FIG. 1 shows an example of the hardware configuration of the image processing apparatus according to the first embodiment. An image processing apparatus 100 is a computer such as a PC, and includes a CPU 101, a RAM 102, an HDD 103, a general-purpose interface (I/F) 104, a monitor 108, and a main bus 109. In addition, an image capturing apparatus 105 such as a camera, an input apparatus 106 such as a mouse or a keyboard, and an external memory 107 such as a memory card are connected to the main bus 109 of the image processing apparatus 100 via the general-purpose I/F 104.

The CPU 101 realizes various types of processing such as those described below by operating in accordance with various types of software (computer programs) stored in the HDD 103. First, the CPU 101 displays a user interface (UI) on the monitor 108 by deploying a program of an image processing application stored in the HDD 103 to the RAM 102 and executing the program. Next, various types of data stored in the HDD 103 or the external memory 107, image data obtained by the image capturing apparatus 105, a user instruction and the like from the input apparatus 106 are transferred to the RAM 102. Furthermore, computation processing that uses data stored in the RAM 102 is performed based on an instruction from the CPU 101 in accordance with processing of the image processing application. The result of the computation processing can be displayed on the monitor 108, and can be stored in the HDD 103 or the external memory 107. Note that image data stored in the HDD 103 or the external memory 107 may be transferred to the RAM 102. In addition, image data transmitted from a server via a network (not illustrated) may be transferred to the RAM 102.

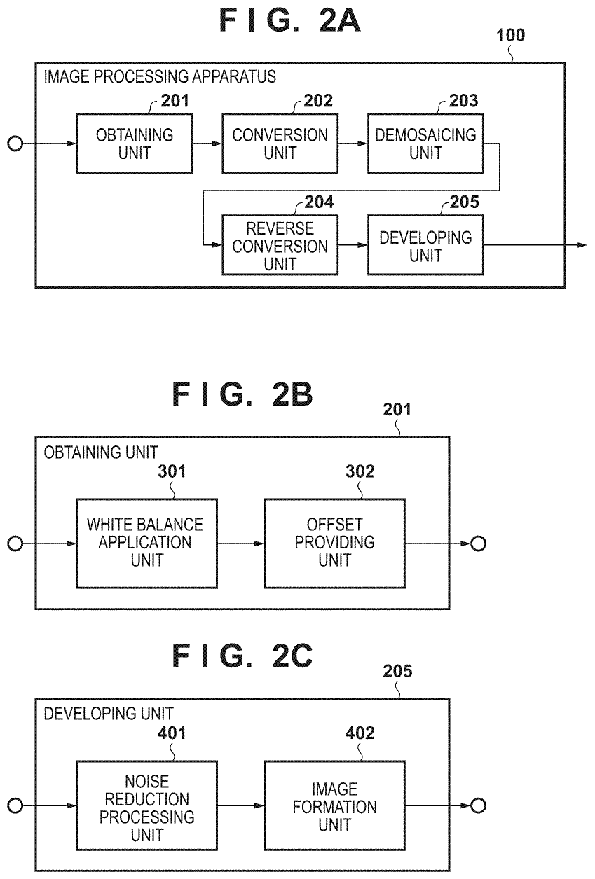

An embodiment will be described below in which, in the image processing apparatus 100 that has a configuration such as that described above, a RAW image data input to the image processing application is developed and the developed image data is output based on an instruction from the CPU 101. Functions of the units shown in FIGS. 2A to 2C, for example, which will be described below, can be realized by a processor such as the CPU 101 executing a program stored in a memory such as the RAM 102 or the HDD 103.

### Neural Network

A convolutional neural network (CNN) will be described as an example of a neural network that can be used in this embodiment. CNN is used in Gharbi, and is used in general image processing techniques in which a deep training technique is applied. CNN refers to a technique for repeating nonlinear computation after convolution of filters generated through training, with respect to an image. Such filters are also called Local Receptive Field (LPF). In addition, an image that is obtained by performing nonlinear computation after convoluting filter with respect to an image is called a “feature map”. In addition, training is performed using training data (training images or data sets) that includes a pair consisting of an input image (also referred to as a “training image”) and an output image (also referred to as a “supervisory image”). The output image is data expected to be obtained by performing CNN processing on an input image, in other words correct answer data. Briefly speaking, generating, from training data, the values of filters that can accurately convert an input image into a corresponding output image is training. A description thereof will be given later.

If a feature map is constituted by a plurality of images, filters to be used for convolution can also include a plurality of channels that correspond to the number of feature maps. That is to say, convolution filters are indicated by a four-dimensional array that corresponds to the number of channels, in addition to a vertical size, a horizontal size, and the number of filters. A pair of processing in which filters are convoluted with respect to an image (or a feature map) and nonlinear computation is then performed is indicated in units of layers. A feature map and a filter at a specific position within CNN, for example, can be indicated by a “feature map on an n-th layer” from the top, a “filter on an n-th layer”, or the like. In addition, for example, CNN that repeats a set consisting of convolution of filters and nonlinear computation three times can be referred to as a “CNN that has a three-layer network structure”.

Such a combination of convolution and nonlinear computation can be expressed by Expression 1 below.

$$( 1 )$$

$${X}_{n}^{( l )} = f ( {\sum }_{k = 1}^{K} {W}_{n}^{( l )} * {X}_{n - 1}^{( l )} + {b}_{t 1}^{( l )} ) \qquad ( 1 )$$

In Expression 1, wn indicates a filter on the n-th layer, bₙ indicates a bias on the n-th layer, f indicates a nonlinear operator, Xₙ indicates a feature map on the n-th layer, and * indicates a convolution operator. Note that (l) indicates an l-th filter or feature map. Filters and biases are generated through training to be described later, and are also called network parameters collectively.

The type of nonlinear computation is not particularly limited, but, for example, a sigmoid function or ReLU (Rectified Linear Unit) can be used. Non-linear computation that complies with ReLU can be expressed by Expression 2 below.

$$( 2 )$$

$$f ( x ) = \{ \begin{matrix}X if 0 \leq X \\ 0 otherwise\end{matrix} \qquad ( 2 )$$

Accordingly, ReLU processing is nonlinear processing for converting a negative element value from among the elements of an input vector X, into zero, and maintaining a positive element value as is.

Next, training of CNN will be described. Training of CNN can be performed by minimizing an objective function that is obtained for training data that includes a pair consisting of an input image (training image) and a corresponding output image (supervisory image). The objective function can be expressed by Expression 3 below, for example.

$$( 3 )$$

$$L ( θ ) = \frac{1}{n} {\sum }_{i = 1}^{n} {‖ F ( {X}_{i} ; θ ) - {Y}_{i} ‖}_{2}^{2} \qquad ( 3 )$$

Here, L that indicates an objective function refers to a loss function for measuring an error between a correct answer (an output image) and inference (a result of CNN processing performed on an input image). In addition, Yᵢ indicates an i-th output image, and Xi indicates an i-th input image. F indicates a function collectively representing computation (Expression 1) that is performed on each of the layers of CNN. θ indicates a network parameter (filter and bias). In addition, ∥Z∥₂ indicates L2 norm of a vector Z, or briefly speaking, a square root of the sum of the squares of the elements of the vector Z. In the objective function in Expression 3, the square of L2 norm is used. In addition, n indicates the number of pieces of training data (the number of sets each consisting of an input image and an output image) to be used for training. Commonly, the total number of pieces of training data is large, and thus, in training that uses Stochastic Gradient Descent (SGD), a portion of training data is randomly selected, and can be used for minimizing the objective function. According to such a method, it is possible to reduce the calculation load in training that uses a large amount of training data.

Various methods such as momentum, AdaGrad, AdaDelta, and Adam can be used as a method for minimizing the objective function (=optimization). Adam that complies with Expression 4 below can be adopted, for example.

$$( 4 )$$

$$g = \frac{\partial L}{\partial {θ}_{i}^{t}} m = {β}_{1} m + ( 1 - {β}_{1} ) g v = {β}_{2} ν + ( 1 - {β}_{2} ) {g}^{2} {θ}_{i}^{t + l} = {θ}_{i}^{t} - α \frac{\sqrt{1 - {β}_{2}^{t}}}{( 1 - {β}_{1} )} \frac{m}{( \sqrt{v} + ϵ ε )} \qquad ( 4 )$$

In Expression 4, θᵢ^{t} indicates an i-th network parameter in t-th repetition, and g indicates a gradient of the loss function L related to θᵢ^{t}. In addition, m and v indicate moment vectors, a indicates a base training rate, β1 and β2 indicate hyper parameters, and c indicates a small constant that can be determined as appropriate. The optimization method that is used is not particularly limited, but it is known that each optimization method has different convergence, and is different in training time, and thus an optimization method can be selected in accordance with intended usage or the like.

A specific configuration of CNN is not particularly limited. ResNet that is used in an image recognition field, RED-Net in a super-resolution field, and the like can be used as a specific configuration of a network that uses CNN. In either case, the accuracy of processing is increased by performing convolution of filters many times using a multi-layer CNN. ResNet has a network structure that includes a path for a shortcut to convolutional layers, for example, and realizes accurate recognition that is almost equivalent to that of the recognizability of a human using a multi-layer network that has 152 layers. Note that, briefly speaking, a reason for a fact that the accuracy of processing increases due to a multi-layer CNN is that CNN can represent the nonlinear relation between input and output by repeating nonlinear computation many times.

### Exemplary Functional Configuration of Image Processing Apparatus

An exemplary functional configuration of the image processing apparatus 100 according to this embodiment will be described with reference to the block diagram in FIG. 2A. Note that the configurations shown in FIGS. 2A to 2C and 4 can be modified or changed as appropriate. One function unit may be divided into a plurality of function units, or two or more function units may be integrated into one function unit, for example. In addition, the configurations shown in FIGS. 2A to 2C and 4 may be realized by two or more apparatuses. In this case, the apparatuses are connected to each other via a circuit or a wired or wireless network, and can realize each type of processing to be described later, by performing data communication with each other and performing a cooperated operation.

The following description is given as if function units shown in FIGS. 2A to 2C and 4 perform processing, but, as described above, the function of a function unit is realized by the CPU 101 executing a computer program corresponding to this function unit. Note that at least some of the function units shown in FIGS. 2A to 2C and 4 may be realized by dedicated hardware. In addition, a case will be described mainly below in which an input image or a RAW image is a Bayer image captured using RGB color filters in a Bayer array. However, an embodiment of the present invention can also be applied to an input image captured using a color filter array other than a Bayer array. In addition, a case will be described below in which each pixel of an input image has R, G, or B color information, and an image that is obtained through development is an RGB image, but color types are not limited to RGB, and the number of colors is not limited to three.

An obtaining unit 201 obtains an input image. The obtaining unit 201 can obtain an input image (which may be data of a RAW image) in which pixels of a plurality of different types of color information in a linear color space are arranged. More specifically, the obtaining unit 201 can obtain, as data of an input image, raw data in a linear color space generated by a digital image capturing apparatus performing image capturing, the digital image capturing apparatus including a single-plate image sensor in which a color filter for one color is mounted at one pixel position. Such an input image has information for only one color at one pixel position. In addition, the obtaining unit 201 can perform, on an input image, preprocessing for inputting the input image to a conversion unit 202. The obtaining unit 201 can perform one or more types of preprocessing, which will be described below, on an input image, and output the input image subjected to the preprocessing, to the conversion unit 202, for example.

FIG. 2B shows an exemplary functional configuration of the obtaining unit 201. As shown in FIG. 2B, the obtaining unit 201 may include a white balance application unit 301 and an offset providing unit 302, as function units for performing preprocessing. The white balance application unit 301 performs processing for applying white balance to an input image. The white balance application unit 301 can multiply the pixel value of each pixel of a RAW image by a gain that is different for each color, based on Expression 5, for example.

$$R a {w}_{W B} = ( Raw - offset ) \times {WB}_{coeff} \qquad ( 5 )$$

In Expression 5, “Raw” indicates a pixel value of RAW image data, and “Raw_{WB}” indicates a pixel value of the RAW image data after white balance processing is applied. In addition, “offset” indicates an offset value added to a pixel value of the RAW image data, and “WB_{coeff}” indicates a white balance coefficient that is determined for each color. In white balance processing, a gain for each color is multiplied, and thus, in the case of a Bayer array, calculation is performed for each of a R pixel, G pixels (G1 and G2), and a B pixel. Note that an offset value and the presence or absence thereof differ according to RAW image data, and may be defined in advance for each image capturing apparatus that captures a RAW image.

The offset providing unit 302 provides an offset value to RAW image data subjected to white balance processing and output from the white balance application unit 301. When the pixel value of each pixel of the RAW image is 13 bits (0 to 8191) and the offset value is 256, for example, the offset providing unit 302 can add the offset value to the pixel value of each pixel of the RAW image. In this case, the offset providing unit 302 can output image data of at least 14 bits (for example, 16 bits). An appropriate value can be determined as the offset value based on the noise amount of the RAW image that is an input image.

Note that the obtaining unit 201 can also perform noise reduction processing on the input image as preprocessing. In addition, the input image obtained by the obtaining unit 201 may have been subjected to preprocessing such as sensor correction or optical correction already.

The conversion unit 202 performs nonlinear conversion on the input image and thereby generates a first image (input image subjected to nonlinear conversion). In this embodiment, nonlinear conversion for emphasizing the contrast can be performed at an aim of improving the interpolation accuracy in the vicinity of an edge as described above. On the other hands, in an embodiment, a different type of nonlinear conversion may be used.

The conversion unit 202 can perform nonlinear conversion for emphasizing the contrast of at least a dark portion, for example. Gamma correction that uses a gamma value smaller than 1 may be performed as nonlinear conversion for emphasizing the contrast of a dark portion. As a specific example, the conversion unit 202 can apply gamma conversion that is based on Expression 5 to the input image.

$$Output = {Input}^{( 1 / 2.2 )} \qquad ( 6 )$$

In Expression 6, “Input” indicates the pixel value of each pixel of the input image, and “Output” indicates the pixel value of a corresponding pixel of the first image.

Note that a certain offset value may be provided in advance to pixels of the input image to which nonlinear conversion is to be applied. As described above, the offset providing unit 302 can provide the offset value to the input image, and, in this case, the conversion unit 202 may apply nonlinear conversion to the input image to which offset value has been provided. In this manner, by applying nonlinear conversion to the input image to which the offset value has been added, even if the input image includes noise, the demosaicing accuracy of a dark portion improves. In addition, also if the input image does not include noise, there are cases where the demosaicing accuracy can be improved by providing an offset value. This is because, by providing the offset value, information regarding a boundary region (specifically, in the vicinity of a black level and in the vicinity of a saturation level) in which training is difficult decreases in the image data that is to be demosaiced. Accordingly, pixel values of the image data approach a range in which favorable training is performed (the trained model can accurately perform inference), and thus the accuracy of demosaicing processing that uses a neural network is expected to improve. On the other hand, nonlinear conversion processing may also be applied to an input image to which an offset value has not been provided.

A demosaicing unit 203 generates a second image (demosaiced image) by performing demosaicing processing on the first image using a neural network. The demosaicing unit 203 can output multi-channel color image data in which color information was interpolated, by performing demosaicing processing on a RAW image subjected to nonlinear conversion and output by the conversion unit 202, using a demosaicing network model obtained through training. In this embodiment, the demosaicing unit 203 can generate RGB image data constituted by an R image, a G image, and a B image.

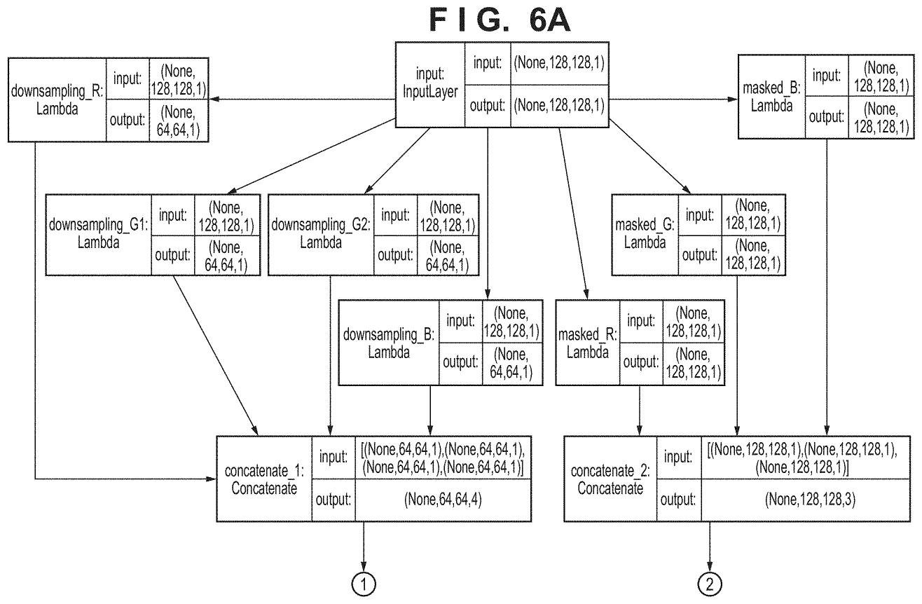

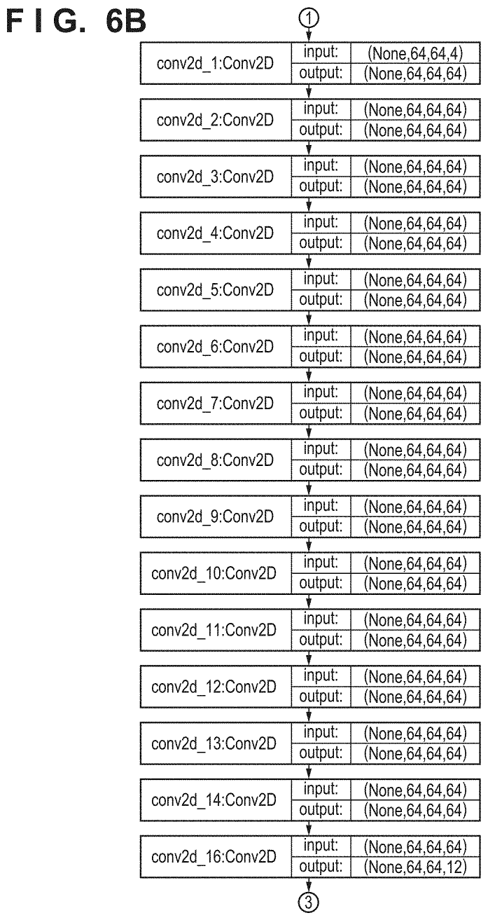

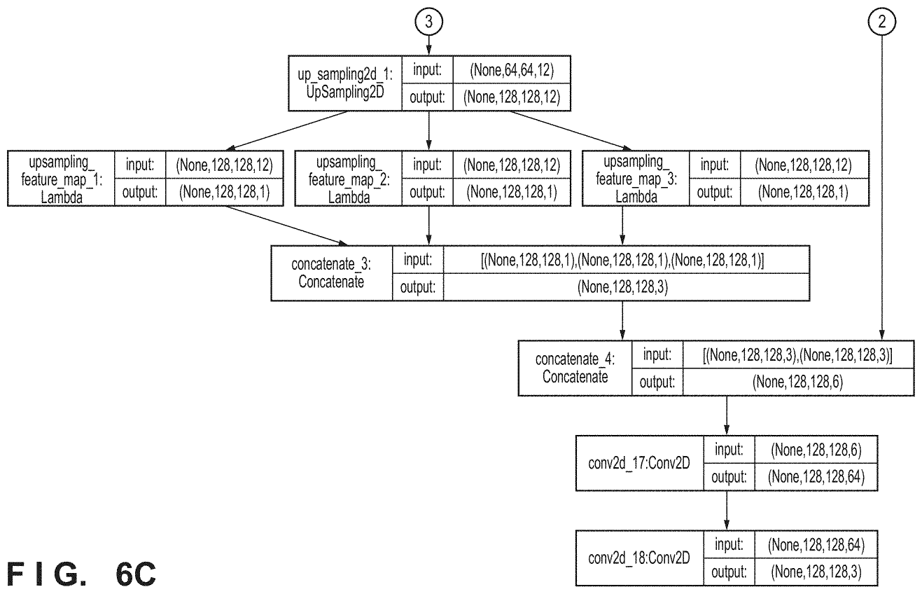

Here, the demosaicing network model refers to an architecture and parameters (coefficients) of a neural network trained so as to perform demosaicing processing. The architecture of the neural network may have a multi-layer CNN such as that described above, as a base, but there is no limitation to this. FIGS. 6A, 6B, and 6C show examples of an architecture of a neural network that can be used in this embodiment. Such a network model can be obtained through training that uses a pair consisting of a mosaic image (training image) and a demosaiced image (supervisory image) as will be described below. Here, as will be described below, a mosaic image used in training can be obtained by sub-sampling a demosaiced image in accordance with an arrangement pattern of pixels of a plurality different pieces of color information, in an input image. That is to say, this sub-sampling can be performed in accordance with the arrangement pattern of color filters that are used by the image capturing apparatus that has captured the input image.

A reverse conversion unit 204 and a developing unit 205 perform development processing on the second image. In this embodiment, the reverse conversion unit 204 generates a third image that has color information in a linear color space, by performing conversion that is reverse to nonlinear conversion applied to the second image by the conversion unit 202. In this manner, the reverse conversion unit 204 can output a third image that is RGB image data in a linear color space by applying, to an R image, a G image, and a B image, reverse conversion processing corresponding to nonlinear conversion applied by the conversion unit 202.

When the conversion unit 202 uses nonlinear conversion indicated in Expression 6, for example, the reverse conversion unit 204 can apply reverse conversion processing indicated in Expression 7.

$$Output = {Input}^{2.2} \qquad ( 7 )$$

In Expression 7, “Input” indicates the pixel value of each pixel of the second image (each of an R image, G images, and a B image), and “Output” indicates the pixel value of a corresponding pixel of the third image (each of an R image, G images, and a B image). Note that, when the conversion unit 202 is performing nonlinear conversion on an input image to which an offset value has been added by the offset providing unit 302 or the like, the reverse conversion unit 204 can subtract this offset value from an image obtained through reverse conversion processing.

The developing unit 205 can perform development processing on the third image obtained by the reverse conversion unit 204. Specifically, the developing unit 205 generates a developing result by performing development processing on an RGB image in a linear color space output from the reverse conversion unit 204.

FIG. 2C shows an exemplary functional configuration of the developing unit 205. As shown in FIG. 2C, the developing unit 205 may include a noise reduction processing unit 401 and an image formation unit 402. The noise reduction processing unit 401 performs noise reduction processing on a third image (for example, an RGB image in a linear color space) output from the reverse conversion unit 204. Note that, if the input image does not include noise, or the obtaining unit 201 performs noise reduction processing, noise reduction processing that is performed by the noise reduction processing unit 401 may be omitted.

The image formation unit 402 obtains a final development processing result (color image) by applying various types of image processing required for image formation to the third image (for example, an RGB image in a linear color space) subjected to noise reduction processing. Dynamic range adjusting processing, gamma correction processing, sharpness processing, color processing, or the like may be used as image processing for image formation.

In dynamic range adjusting processing, an input lower limit value Bk and an input upper limit value Wt that are used during development are determined. In processing subsequent to dynamic range adjusting processing such as gamma correction processing, an input value ranging from the input lower limit value Bk to the input upper limit value Wt is allocated to an output value. Here, by determining the input lower limit value Bk and the input upper limit value Wt in accordance with luminance distribution and the like of an image, it is possible to obtain high-contrast development data. In addition, noise in a dark portion can be removed by increasing the input lower limit value Bk, and it is possible to suppress blown-out highlight by increasing the input upper limit value Wt.

In gamma correction processing, the contrast and the dynamic range of an entire image are adjusted using a gamma curve. In sharpness processing, an edge in the image is emphasized, and the sharpness of the entire image is adjusted. In color processing, it is possible to change the hue or saturation in the image, or to suppress a color curving in a high luminance region.

Processing that is performed by the image formation unit 402 is not limited to those described above. A variety of processing, including changing the order of processing, can be adopted as processing that is performed by the image formation unit 402.

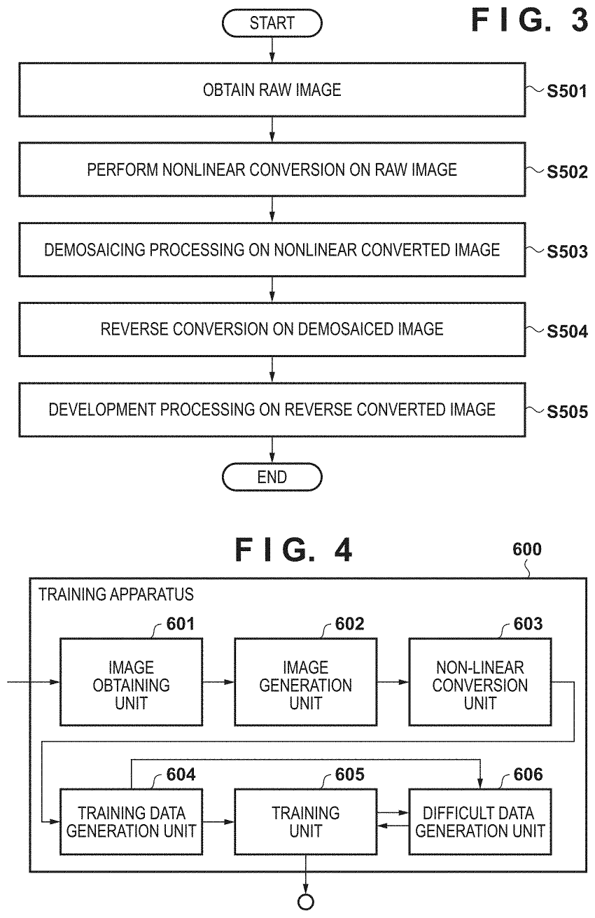

Next, a development processing method that is performed on an input image, which is an image processing method according to this embodiment that is performed by the image processing apparatus 100 according to this embodiment, will be described with reference to the flowchart in FIG. 3. In step S501, the obtaining unit 201 reads an input image that is to be subjected to development processing, from the image capturing apparatus 105, the HDD 103, the external memory 107 or the like. Here, the obtaining unit 201 can perform preprocessing such as white balance processing or offset addition processing on the input image as described above.

In step S502, the conversion unit 202 generates a first image by performing nonlinear conversion on the input image obtained in step S501, as described above. In step S503, the demosaicing unit 203 performs demosaicing processing on the first image generated in step S503 using a trained demosaicing network model as described above, and generates a second image subjected to interpolation. In step S504, the reverse conversion unit 204 applies reverse conversion processing corresponding to nonlinear conversion processing performed in step S502, to the second image output in step S503, and outputs a third image in a linear color space.

In step S505, the developing unit 205 performs development processing on the third image in a linear color space output in step S504, and generates and outputs a development processing result (color image). Output destination of the development processing result is not particularly limited, and may be the HDD 103, the external memory 107, or another device that is connected to the general-purpose I/F 104 (such as an external apparatus that is connected to the image processing apparatus 100 via a network), for example.

In this manner, according to this embodiment, demosaicing processing in a color space in which the contrast has been increased and that has been subjected to nonlinear conversion is performed by performing nonlinear processing on an input image in a linear color space. At this time, inference (demosaicing processing) can be performed using a network model trained based on image data in a color space, not in not a linear color space, in which the contrast has been increased and that has been subjected to nonlinear conversion. With this configuration, the accuracy of the demosaicing processing can be improved. According to an embodiment of the present invention, for example, it is possible to obtain a development result (color image) in which moire is suppressed and the bandwidth is broadened.

### Second Embodiment

The image processing apparatus according to the first embodiment performs development of an image using a trained neural network for demosaicing processing. A training apparatus according to the second embodiment performs training processing for generating a neural network for demosaicing processing. The image processing apparatus according to the second embodiment can generate a demosaicing network model that can be used by the image processing apparatus according to the first embodiment, for example. The image processing apparatus according to the second embodiment can have a hardware configuration similar to that in the first embodiment, and a description thereof is omitted.

An exemplary functional configuration of a training apparatus 600 according to the second embodiment will be described with reference to FIG. 4. An image obtaining unit 601 obtains a fourth image that has color information in a linear color space. The method for obtaining a fourth image is not particularly limited, but a case will be described below in which a fourth image is generated from RAW image data.

The image obtaining unit 601 obtains RAW image data that is a fourth image having color information in a linear color space. This image data corresponds to an image in which pixels of a plurality of different pieces of color information in a linear color space are arranged. This RAW image data may be raw data generated by an image capturing apparatus that has color filters in a Bayer array performing image capturing, for example.

An image generation unit 602, a conversion unit 603, and a training data generation unit 604 generate a set consisting of a supervisory image that has color information in a nonlinear color space and a training image that is a mosaic image of the supervisory image, based on the fourth image. The image generation unit 602 generates a supervisory image in a linear color space based on the fourth image. The image generation unit 602 can generate an RGB image in a linear color space as a correct answer image by interpolating, based on RAW image data that has information regarding only one color at a pixel position, information regarding the remaining two colors, for example.

Incidentally, as will be described later, the conversion unit 603 generates a supervisory image to be used for training by performing nonlinear conversion on a supervisory image in a linear color space. Therefore, the accuracy of demosaicing processing that uses a neural network obtained through training is expected to be improved by using a high-quality image, for example, a supervisory image in a linear color space having few false colors. In view of this, in this embodiment, the image generation unit 602 can generate, from the fourth image, a supervisory image in a linear color space that is a fifth image, using the following method. This supervisory image is an image in which each pixel has information regarding a plurality of colors, such as an RGB image.

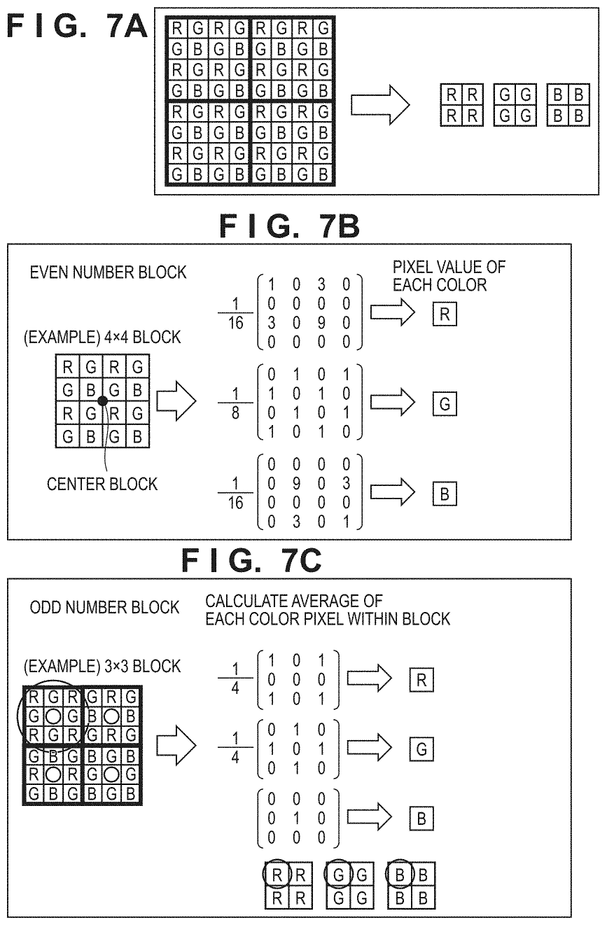

As shown in FIGS. 7A to 7C, for example, the image generation unit 602 can generate a supervisory image in a linear color space by reducing the fourth image. In the example in FIG. 7A, an RGB image whose resolution has been reduced to ¼ such that each 4×4 pixel block in a RAW image corresponds to one pixel is generated as a supervisory image. In this case, the pixel value of one pixel can be obtained from the pixel values included in a corresponding 4×4 pixel block, and thus it is possible to suppress occurrence of a false color. Specifically, as shown in FIG. 7B, the R pixel value, the G pixel value, and the B pixel value of one pixel in the supervisory image can be calculated based on the R pixel values, the G pixel values, and the B pixel values included in a corresponding 4×4 pixel block in the fourth image. Here, as shown in FIG. 7B, when a pixel block including pixels of an even number of rows and an even number of columns is reduced to one pixel, pixels of the same color do not uniformly distribute with respect to the center of the block. For this reason, as shown in FIG. 7B, the pixel value of one pixel in the supervisory image can be obtained by weight-combining pixel values of the same color included in the pixel block. In addition, as shown in FIG. 7C, when a pixel block including pixels of an odd number of rows and an odd number of columns is reduced to one pixel, pixels of the same color uniformly distribute with respect to the center of the block. For this reason, as shown in FIG. 7C, the pixel value of one pixel of a supervisory image can be obtained by averaging pixel values of the same color included in the pixel block. Note that a specific reducing method is not particularly limited.

In addition, the image generation unit 602 may also generate a supervisory image in a linear color space from the fourth image by using demosaicing processing. The demosaicing technique that is used is not particularly limited, but the image generation unit 602 can use a demosaicing technique that can suppress occurrence of a false color or can perform processing for reducing a false color that has occurred.

In addition, an image reduced as described above or an image subjected to interpolation through demosaicing processing can be further subjected to reducing processing that uses a technique of bicubic interpolation or the like, the reducing processing being performed by the image generation unit 602. Due to such reducing processing, it is possible to decrease the influence of distortion aberration or the like. Here, in reduction, it is possible to use a reducing method in which aliasing is not likely to occur, in order to prepare an image with few false colors or moire as a correct answer image.

Note that, here, a case has been described in which the image obtaining unit 601 obtains a mosaic image such as a Bayer image, and the image generation unit 602 converts the mosaic image into an RGB image (that is to say, an image in which each pixel has an R pixel value, a G pixel value and a B pixel value). However, the image obtaining unit 601 may obtain an image in which each pixel has a plurality of pieces of color information, such as an RGB image. The image obtaining unit 601 may obtain an RGB image in a linear color space captured using a three plate-type image capturing apparatus, for example. In this case, the image generation unit 602 can be omitted.

The conversion unit 603 generates a supervisory image in a nonlinear color space by performing nonlinear conversion on a supervisory image in a linear color space generated by the image generation unit 602. This processing can be performed similarly to the conversion unit 202 according to the first embodiment.

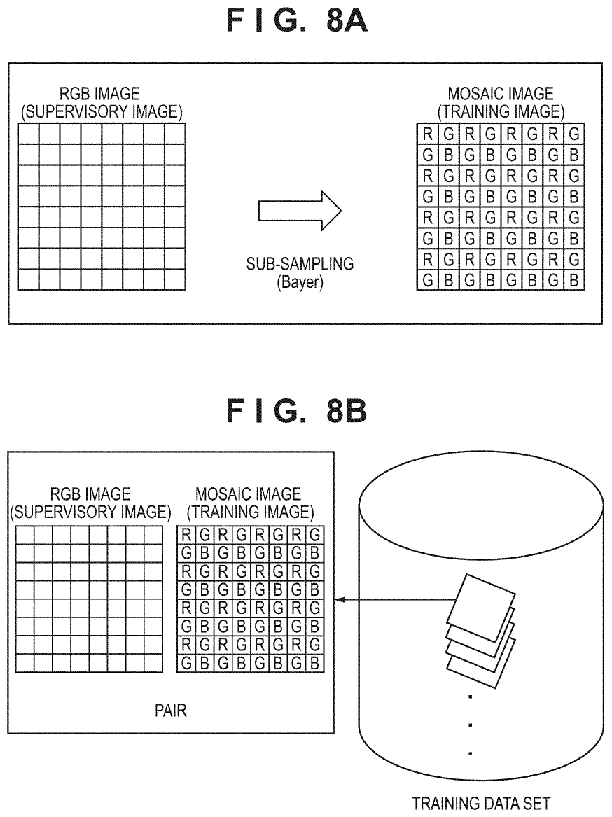

The training data generation unit 604 generates a training image that is a mosaic image, by performing mosaicing processing on a supervisory image in a nonlinear color space generated by the conversion unit 603. The training data generation unit 604 can generate a training image by performing sub-sampling that is based on a color filter array, on an R image, a G image, and a B image that are supervisory images, as shown in FIG. 8A. Here, a color filter array of the image capturing apparatus that captures a RAW image that is a target of demosaicing processing that uses a trained neural network can be referenced for sub-sampling.

The image generation unit 602, the conversion unit 603, and the training data generation unit 604 can generate a training image group and a corresponding supervisory image group by performing the above-described processing on an image group that includes a plurality of images obtained by the image obtaining unit 601. The training data generation unit 604 can generate training data sets that include a plurality of sets consisting of a training image and a supervisory image, as shown in FIG. 8B. Note that only the supervisory image group may be included in the training data sets. In this case, a training unit 605 to be described later can generate a training image from a supervisory image, similarly to the training data generation unit 604.

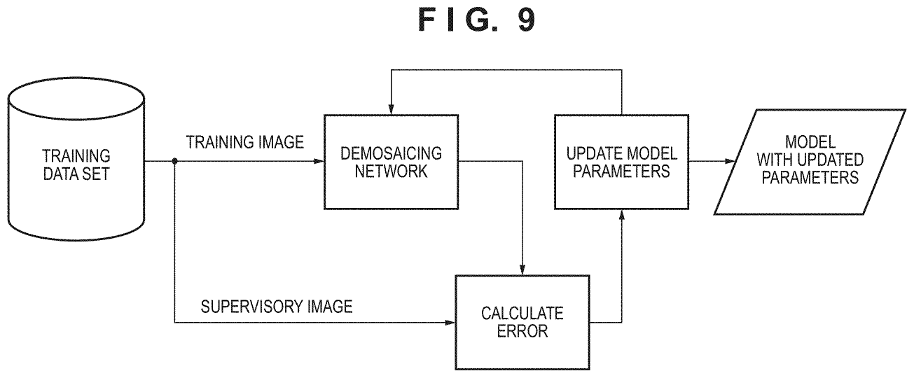

The training unit 605 generates a preliminarily-trained model by training a neural network using training data sets generated by the training data generation unit 604. Specifically, the training unit 605 extracts a correct answer image group and a training image group from the training data sets, and performs demosaicing processing on the training image group using the neural network. Next, the training unit 605 compares an output result from the neural network (a demosaiced image obtained from a training image) with a supervisory image, and updates parameters of the neural network so as to feedback an error. The training unit 605 then continues to further update the parameters of the neural network by performing similar processing using the updated neural network. A specific method for updating parameters has been described in the first embodiment already. The training unit 605 generates a preliminarily-trained model by repeating update of parameters until a predetermined condition is satisfied, based on a selected optimization technique. FIG. 9 shows a flow of data of the above processing.

The neural network trained by the training unit 605 can be used for demosaicing processing, but, in this embodiment, a preliminarily-trained model is further trained in order to increase the processing accuracy. A difficult data generation unit 606 generates a new training data set by selecting a portion of training data sets. Training data that is selected here is a set consisting of a training image and a supervisory image in which accurate demosaicing processing is difficult, and is referred to as “difficult data”.

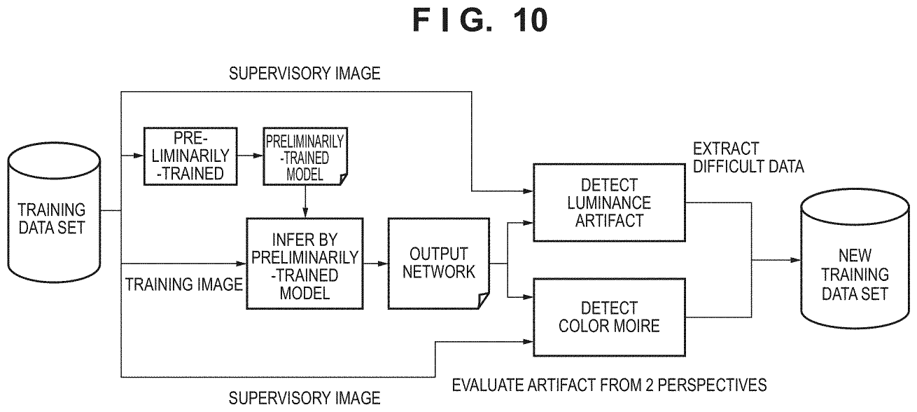

The difficult data generation unit 606 can extract difficult data based on the difference between a result of demosaicing processing performed on a training image using the preliminarily-trained model and a supervisory image corresponding to the training image, for example. Specifically, the difficult data generation unit 606 obtains a demosaiced image group by performing inference (demosaicing) processing on a training image group included in the training data sets, using the preliminarily-trained model obtained by the training unit 605. The difficult data generation unit 606 can extract an image group in which the perceived difference is large, by comparing the obtained demosaiced image with a corresponding supervisory image included in the training data sets based on a quantitative evaluation technique. The method used in Gharbi can be adopted as the quantitative evaluation technique, for example. As a specific example of the quantitative evaluation technique, a set consisting of a training image and a supervisory image in which one of the amount of occurrence of luminance artifact and the amount of occurrence of color moire exceeds a reference value can be extracted as difficult data, based on an index indicating the amount of occurrence of luminance artifact and an index indicating the amount of occurrence of color moire. FIG. 10 shows a flow of data of the following processing.

The training unit 605 then trains a neural network that performs demosaicing processing again using the training data sets generated by the difficult data generation unit 606. A specific training method has been described above. Here, the training unit 605 may further train the preliminarily-trained model using the training data sets generated by the difficult data generation unit 606. That is to say, the training unit 605 may perform fine tuning of the preliminarily-trained model. In this case, in order to improve the processing accuracy, the training unit 605 can perform retraining of the weights of all of the layers, while using the weights of the layers of the preliminarily-trained model as initial values.

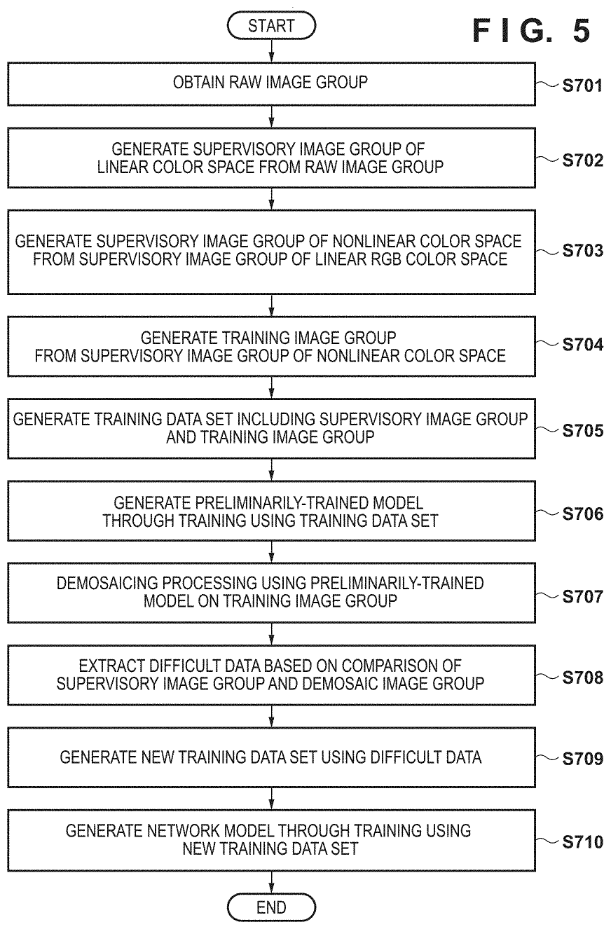

Next, a training method according to this embodiment that is performed by the training apparatus 600 according to this embodiment will be described with reference to the flowchart in FIG. 5. In step S701, the image obtaining unit 601 obtains a RAW image group from the image capturing apparatus 105, the HDD 103, the external memory 107, or the like. In step S702, the image generation unit 602 generates a supervisory image group in a linear color space as described above from the RAW image group obtained in step S701. In step S703, the conversion unit 603 generates a supervisory image group in a nonlinear color space as described above by performing nonlinear conversion on the supervisory image group in a linear color space obtained in step S702. In step S704, the training data generation unit 604 generates a training image group as described above by performing sub-sampling on the supervisory image group in a nonlinear color space obtained in step S703, based on a color filter array. In step S705, the training data generation unit 604 generates training data sets in which the supervisory image group obtained in step S703 and the training image group obtained in step S704 are paired, as described above.

In step S706, the training unit 605 generates a preliminarily-trained model as described above by training a neural network using the training data sets obtained in step S704. In step S707, as described above, the difficult data generation unit 606 obtains a demosaiced image group by performing demosaicing processing on the training image group using the preliminarily-trained model obtained in step S706. In step S708, the difficult data generation unit 606 extracts difficult data from the training data sets as described above based on comparison between the demosaiced image group and the supervisory image group. In step S709, the difficult data generation unit 606 generates a new training data set using the difficult data extracted in step S708. In step S710, the training unit 605 trains the neural network as described above using the training data sets generated in step S709. In this manner, the neural network is trained for demosaicing processing, and it is possible to obtain a demosaicing network model that is output of the training apparatus according to this embodiment.

### Third Embodiment

In the first and second embodiments, the image processing apparatus 100 performs development processing on an image captured by the image capturing apparatus 105, and the training apparatus 600 performs training processing. However, the above-described development processing and training processing may be performed by the image capturing apparatus 105. In this case, a configuration may be adopted in which hardware for the above-described development processing and training processing is provided in the image capturing apparatus 105, and the above-described development processing and training processing are performed using this hardware. In addition, a computer program for the above-described development processing and training processing is stored in a memory of the image capturing apparatus 105, the above-described development processing and training processing are executed by a processor of the image capturing apparatus 105 executing this computer program. In this manner, the above-described configurations of the image processing apparatus 100 and the training apparatus 600 can be incorporated in the image capturing apparatus 105.

In addition, the image processing apparatus 100 may perform development processing on a captured image transmitted from a client apparatus via a network, and register an image obtained through the development processing to the image processing apparatus 100 itself or return the image to the client apparatus. It is also possible to provide a development processing system that uses such the image processing apparatus 100. The training apparatus 600 may also be incorporated in such a development processing system. In addition, the image processing apparatus 100 may also have the functions of the training apparatus 600.

An embodiment of the present invention can improve the interpolation accuracy of demosaicing processing in development processing of a RAW image obtained by an image capturing apparatus.

### Processing Example

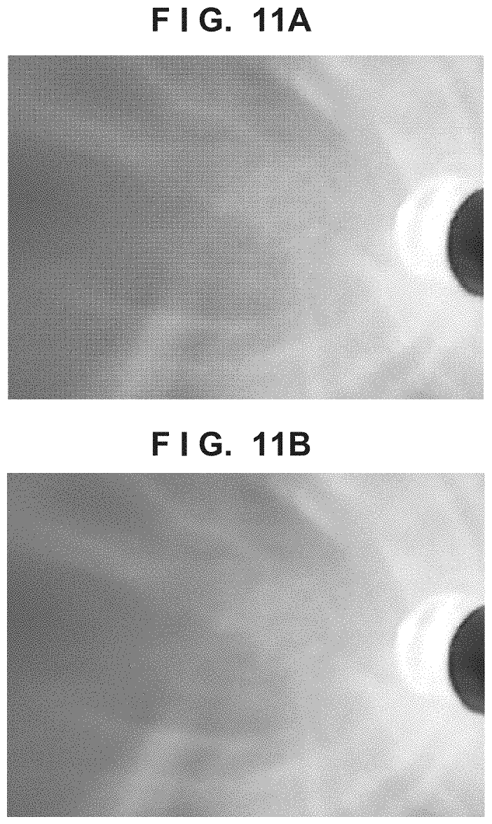

FIG. 11B shows an image obtained by performing, on an image subjected to nonlinear conversion, demosaicing processing that uses a neural network according to the first embodiment. The used neural network is obtained through training according to the second embodiment. On the other hand, FIG. 11A shows an image obtained by performing demosaicing processing that uses a neural network obtained through training that complies with a conventional technology, on an image in a linear color space that has not been subjected to nonlinear conversion. In the image shown in FIG. 11B, moire is suppressed compared with the image shown in FIG. 11A, and it can be seen that the interpolation accuracy of demosaicing processing is improved according to the above embodiment.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. An image processing apparatus comprising one or more processors and one or more memories storing one or more programs which cause the one or more processors to:
generate first image data from RAW image data by performing nonlinear conversion;
generate second image data by performing a demosaicing process on RAW image data using a neural network trained using the first image data; and
perform a development process using the second image data.

2. The image processing apparatus according to claim 1, wherein the nonlinear conversion is processing for improving a contrast of an image.

3. The image processing apparatus according to claim 2, wherein the nonlinear conversion is processing for improving a contrast in a dark portion of an image.

4. The image processing apparatus according to claim 1, wherein the nonlinear conversion is gamma conversion.

5. The image processing apparatus according to claim 1, wherein the one or more programs cause the one or more processors to generate third image data that has color information in a linear color space, by performing conversion that is reverse to the nonlinear conversion on the second image data.

6. The image processing apparatus according to claim 5, wherein the one or more programs cause the one or more processors to perform gamma correction on the third image data.

7. The image processing apparatus according to claim 6, wherein the one or more programs cause the one or more processors to perform the gamma correction after performing a noise reducing process on the third image data.

8. The image processing apparatus according claim 1, wherein the one or more programs cause the one or more processors to perform processing for applying white balance to the RAW image data, and then perform the nonlinear conversion.

9. The image processing apparatus according to claim 8, wherein the one or more programs cause the one or more processors to perform processing for applying white balance to the RAW image data, and further perform the nonlinear conversion after providing an offset value to each pixel.

10. The image processing apparatus according claim 1, wherein the neural network is trained using a set consisting of the first image data and a mosaic image data obtained from the first image data.

11. The image processing apparatus according to claim 1, wherein the neural network is a neural network obtained by a training apparatus comprising one or more processors and one or more memories storing one or more programs which cause the one or more processors to:
generate a set consisting of supervisory image data that has color information in a nonlinear color space and training image data that is mosaic image data of the supervisory image data, based on RAW image data; and
train a neural network for performing a demosaicing process, based on the set consisting of the supervisory image data and the training image data.

12. An image capturing apparatus comprising:
an image capturing sensor; and
one or more processors and one or more memories storing one or more programs which cause the one or more processors to:
generate first image data from RAW image data obtained by the image capturing sensor, by performing nonlinear conversion;
generate second image data by performing a demosaicing process on RAW image data using a neural network trained using the first image data;
perform a development process using the second image data;
generate a set consisting of supervisory image data that has color information in a nonlinear color space and training image data that is mosaic image data of the supervisory image data, based on the RAW image data; and
train the neural network that is used for a demosaicing process, based on the set consisting of the supervisory image data and the training image data.

13. The image capturing apparatus according to claim 12, wherein the one or more programs cause the one or more processors to generate, from the RAW image data, image data in which each pixel has a plurality of pieces of color information, and generate the supervisory image data by performing nonlinear conversion on the image data in which each pixel has a plurality of pieces of color information.

14. The image capturing apparatus according to claim 13, wherein the one or more programs cause the one or more processors to generate image data in which each pixel has a plurality of pieces of color information, by performing a reducing process or a demosaicing process on the RAW image data.

15. The image capturing apparatus according to claim 13, wherein the one or more programs cause the one or more processors to generate the training image data by performing a mosaicing process on the supervisory image data.

16. The image capturing apparatus according to claim 12, wherein the one or more programs cause the one or more processors to:
select a portion of the plurality of sets based on a difference between a result of the demosaicing process performed on the training image data using the neural network obtained through training and the supervisory image data corresponding to the training image data; and
train a neural network that performs a demosaicing process again using the selected set.

17. An image processing method comprising:
generating first image data from RAW image data by performing nonlinear conversion;
generating second image data by performing a demosaicing process on RAW image data using a neural network trained using the first image data; and
performing a development process using the second image data.

18. A non-transitory computer-readable medium storing one or more programs which, when executed by a computer comprising one or more processors and one or more memories, cause the computer to:
generate first image data from RAW image data by performing nonlinear conversion;
generate second image data by performing a demosaicing process on RAW image data using a neural network trained using the first image data; and
perform a development process using the second image data.
